(19) United States
(12) Patent Application Publication
(10) Pub. No.: US 2026/0164224 A1
(43) Pub. Date: Jun. 11, 2026

(54) ADAPTIVE DELIVERY OF PUBLIC WARNING SYSTEM COMMUNICATIONS

(71) Applicant: T-MOBILE INNOVATIONS LLC, Overland Park, KS (US)

(72) Inventor: Reman PEZHUMKAD BALAKRISHNA, Nutley, NJ (US)

(21) Appl. No.: 18/976,013

(22) Filed: Dec. 10, 2024

(51) Int. Cl. H04W 4/90; H04W 24/04

(52) U.S. Cl. CPC H04W 4/90; H04W 24/04

(57) ABSTRACT

Embodiments of the present disclosure are directed to systems and methods for mitigating errors in transmission of Public Warning System (PWS) communications. According to various aspects of the technology, a PWS communication is received at a telecommunications network. Based on a determination that a first node associated with the telecommunications network is impaired, a mitigation step is transmitted to at least one UE through a second node communicatively connected to the telecommunications network, wherein the mitigation step comprises a set of instructions to adjust a transmission of the PWS communication. When it is determined that the PWS communication was received by the at least one UE, and an instruction to halt the at least one mitigation step is transmitted to the at least one UE.

### SUMMARY

A high-level overview of various aspects are provided here for that reason, to provide an overview of the disclosure and to introduce a selection of concepts that are further described in the detailed description section below. This summary is not intended to identify key features or essential features of the claimed subject matter, nor is it intended to be used as an aid in isolation to determine the scope of the claimed subject matter. The present disclosure is directed, in part, to adaptive delivery of Public Warning System (PWS) communications, substantially as shown in and/or described in connection with at least one of the figures, and as set forth more completely in the claims.

In aspects set forth herein, and at a high level, the technology described herein relates to adaptive delivery of PWS communications. A PWS communication is a high-importance communication that is sent to a large number of recipients at once to convey a message relevant to the public. Often, PWS communications are not received for various reasons. Here, aspects are disclosed where delivery of PWS communications can be tracked and monitored such that delivery problems are identified and remedied.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts a diagram of a network environment, in accordance with aspects herein;

FIG. 2 is a flow chart illustrating determining and taking mitigation steps, in accordance with aspects herein;

FIG. 3 is a flow chart of a method for the adaptive delivery of Public Warning System Communications, in accordance with aspects herein;

FIG. 4 depicts an example of a computer environment, in accordance with one or more aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE (User Equipment) and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, PWS communications are transmitted to User Equipment (UE). These PWS communications are carried to the UEs by system information blocks (SIBs) which are periodically transmitted to UEs. As such, a UE will recognize that an SIB contains a PWS communication. That being said, there can be issues with the decoding of an SIB which contains a PWS communication. As such, a UE may be aware that an SIB contains a PWS communication but be unable to decode the PWS communication. This can be due to any number of impairments associated with the UE, a node of a network, or the network itself.

Conventionally, when a UE is unable to decode a PWS communication, the PWS communication will be resent a number of times until the PWS is received by the UE. But, there are no actions that the UE or network conventionally take when a PWS communication cannot be decoded. As such, there is a reasonably high chance that a UE will never receive a PWS communication or will receive the PWS communication at a time that is less helpful for the warning.

Unlike conventional solutions, the present disclosure provides a solution by which the network, UE, or, a PWS Resolver may take actions in order to ensure that PWS communications are received by UEs in a timely manner. These actions may include any number of mitigation steps taken by the UE, network, or PWS Resolver. Such mitigation steps may include for example, a release with redirect, handover, instructions to enter a roaming state or cell barring. Additionally or alternatively, different mitigation steps may be taken based on the severity level of the PWS communication. A PWS communication with a high priority may trigger a mitigation step such as release with redirect, whereas a low severity level may trigger a handover.

Accordingly, a first aspect provided herein is directed to a non-transitory computer storage media storing computer-useable instructions that, when used by one or more processors, cause the processors to receive, at a telecommunication network, a PWS communication. The processors are further caused to, based on a determination that a first node associated with the telecommunication network is impaired, transmit a mitigation step to at least one UE through a second node communicatively connected to the telecommunication network, wherein the mitigation step comprises a set of instructions to adjust a transmission of the PWS communication. The processors are further caused to, determine that the PWS communication was received by the at least one UE, and transmit an instruction to the at least one UE to halt the at least one mitigation step.

A second aspect provided herein is directed to a system comprising one or more computer processing components configured to perform operations comprising receiving, at a telecommunication network, a PWS communication. The operations further comprise, based on a determination that a first node associated with the telecommunication network is impaired, transmitting at least one mitigation step to a second node associated with the telecommunication network, wherein the mitigation step comprises a set of instructions to adjust a transmission of the PWS communication. The operations further comprise determining that the PWS communication was received by at least one UE, and transmitting an instruction to the second node associated with the telecommunication network, wherein the instruction comprise halting the at least one mitigation step.

Another aspect provided herein is directed to a method for mitigating errors in a transmission of a PWS communication comprising receiving an indication that a PWS communication is being transmitted to at least one UE, determining that the UE did not receive the PWS communication, transmitting a mitigation step to the UE, wherein the mitigation step comprises a set of instructions to adjust the transmission of the PWS communication, and determining that the UE received the PWS communication.

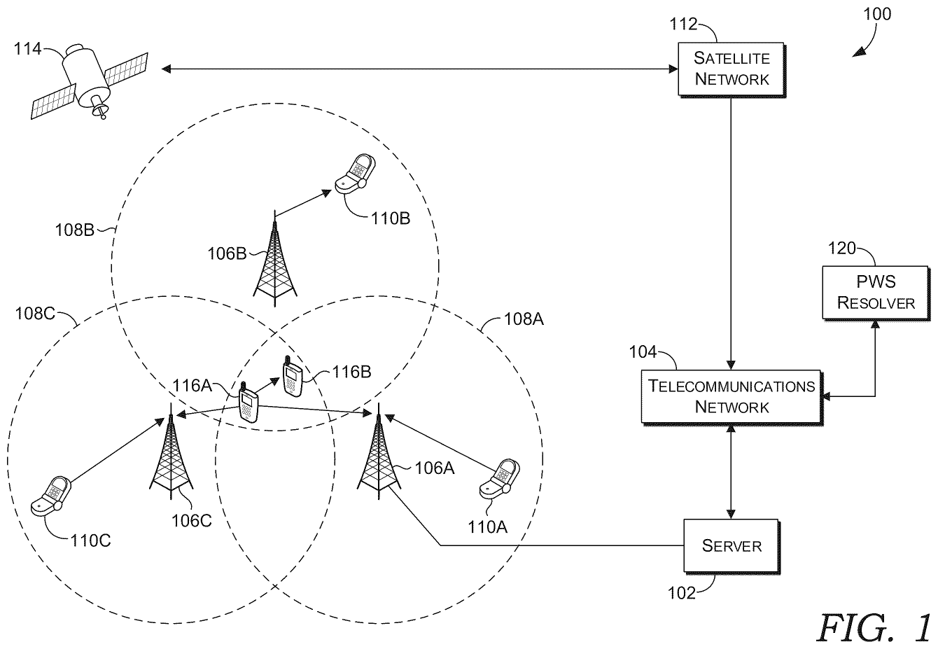

FIG. 1 depicts an example of a network environment 100, in accordance with aspects herein. The network environment 100 includes a server 102 having one or more processors. The server 102 operates within and thus is communicatively coupled to a telecommunications network 104 or its components. The server 102 is communicatively coupled to one or more base stations 106A, 106B, and 106C within the telecommunications network 104. In embodiments, the telecommunications network 104 or server 102 are in communication with a PWS Resolver 120. Each of the one or more base stations 106A, 106B, and 106C is associated with corresponding coverage areas 108A, 108B, and 108C. The one or more base stations 106A, 106B, and 106C can provide telecommunications services to a user device over any number of locations such as user device location 110A, user device location 110B, and user device location 110C. One or more user devices associated with user device location 110A, user device location 110B, and user device location 110C may be such a device represented by computing device 400. As illustrated in FIG. 1, the one or more base station coverage areas 108A, 108B, and 108C may overlap partially or completely with one another and may overlap with one or more areas covered by a satellite such as satellite 114. As such, a UE may be connected to a single base station as a primary cell, but may be capable of connecting to more than one base station from any given location. As discussed in more detail below, a UE connection may move or be moved from one base station to another, or from one base station to a satellite based on determined mitigation actions. Additionally or alternatively, a UE connection may maintain a connection with a base station, but change to a roaming provider based on mitigation actions.

The PWS Resolver 120 may be a hardware or software computing component communicatively coupled to the telecommunications network 104 and any number of UEs such as UEs 202. A PWS communication may be any communication, such as emergency alerts transmitted to UEs through a combination of governmental agencies and mobile network operators. When an emergency situation arises, authorized authorities—such as weather services, public safety organizations, or government bodies—generate an alert message. This message is then sent to mobile network operators, who disseminate it across their network using a Cell Broadcast system or SMS. Cell Broadcast are commonly used as they send a single message to all phones in a designated geographic area. This allows for the communication of the PWS communication to users which do not subscribe to the service, and it can reach many UEs simultaneously without overloading the network.

Once the alert is broadcast, UEs in the affected area that are compatible with the technology and have the necessary settings enabled will automatically receive the message. The UEs process the alert and typically display it whether or not the UE is in silent mode. The alert may include information like the type of emergency, instructions for safety, and sometimes a link for more details. The reception is immediate, and because it is a system-level notification, it bypasses typical messaging apps to ensure the message reaches users as quickly and reliably as possible. These PWS communications piggy back on SIB transmissions that are regularly communicated to UEs, but the PWS must be decoded by the UE in order to determine the contents of the PWS once received. As discussed above, congestion or errors with nodes of a telecommunications network, such as telecommunications network 104 may inhibit a UEs ability to decode the PWS communication. One solution to adapt to issues in a telecommunications network 104 is the PWS Resolver 120.

The PWS Resolver 120 may be connected to the UEs via a software application on the UE. This software application may be a downloaded software linked to the PWS Resolver 120, or may be a non-downloadable cloud-based software which facilitates communication between the UEs and the PWS Resolver 120. The PWS Resolver may receive periodic updates regarding the status of the network connection through communications from the UEs or the network. In embodiments, the PWS Resolver 120 receives periodic updates from the UEs indicating that certain nodes are congested or malfunctioning. This information is then used to determine if mitigation steps are necessary for the UEs associated with that node. In additional or alternative embodiments, the PWS Resolver 120 can determine if mitigation steps are required on a UE-by-UE basis without the need for aggregate data received from more than one UE. The PWS Resolver 120 may additionally or alternatively receive information directly from the telecommunications network 104 to determine if mitigation steps are needed and which mitigation steps to use. In said embodiments, the PWS Resolver 120 receives information indicating what nodes are properly functioning and which nodes are congested and malfunctioning. The PWS Resolver 120 then utilizes said information to determine which UEs are associated with which nodes to determine which UEs require mitigation steps. The PWS Resolver 120 may additionally or alternatively determine the severity level of the PWS communication and adjust the mitigation steps accordingly.

In the network environment 100 shown, the telecommunications network 104 interfaces with satellite network 112, which is also referred to as an aerospace network. In one aspect, the server 102 operates as, or is communicatively coupled to, a telecommunications core network component that acts as an interface between the satellite network 112 and the telecommunications network 104. The satellite network 112 can include one or more devices configured to act as aerospace access points, such as satellite 114. Although not shown, the satellite network 112 may interface with and communicate with one or more terrestrial radio elements that are not associated with the telecommunications network 104. The satellite 114 can provide connectivity to a user device such as a user device located at user device locations 110A, 110B, and 110C which are located within the coverage area of the satellite 114.

In aspects, the user device associated with user device location 110A that is located within coverage area 108A communicates with the base station 106A, such that the base station 106A provides the user device associated with user device location 110A with connectivity to and services of the telecommunications network 104. In one such aspect, the user device associated with user device location 110A sends communications to the base station 106A over an uplink channel. Meanwhile, the user device associated with user device locations 110A, 110B, and 110C which are located within the coverage area of the satellite 114 may send communications to the satellite 114 over an uplink channel. These communications of the user device associated with user device locations 110A, 110B, and 110C may be transmitted using the same particular radio frequencies designated for the uplink channel, and which are being used by the user device associated with user device locations 110A, 110B, and 110C to communicate with the base station 106A, 106B, and 106C.

A user device located at user device location 110A, which is currently connected to base station 106A, may be caused to disconnect from base station 106A and connect to another base station such as base station 106B, or 106C, or may be caused to connect to satellite 114. For example, if a mitigation step is required in order to deliver a PWS communication, the mitigation step may include a handover, release with redirect, or instructions to enter roaming which causes either the base station to disconnect from the user device and facilitate connection to a new base station, or causes the user device to disconnect from a base station and search for a new base station or satellite to which it may connect. Due to the proximity and/or at least a partial overlap of the coverage area of the satellite 114 with the coverage area 108A of the base station 106A, the use of the same radio frequencies by the user device associated with user device location 110B and the user device associated with user device location 110A can allow for communication between coverage areas. As such, in embodiments, when a mitigation step is required, a user device may connect to the nearest alternative base station, or the nearest alternative base station may connect the user device after the initial base station is determined to be impaired.

In additional or alternative embodiments, the same user device may be located at each of user device location 110A, user device location 110B, and user device location 110C. The user device may determine that it has moved locations utilizing GPS or any other form of location determination system. For example, a user device may determine that it has moved from user device location 110A to user device location 110B by determining that the user device has disconnected from base station 106A and is now connected to base station 106B. Similarly, a user device may determine changes in location utilizing GPS data such as GPS data from a satellite such as satellite 114. This may be used to determine that a user device has moved from user device location 110A to user device location 110A, 110B, and 110C. In said embodiment, it is not the change in base station necessarily that is used to determine that the user device has moved, but GPS data.

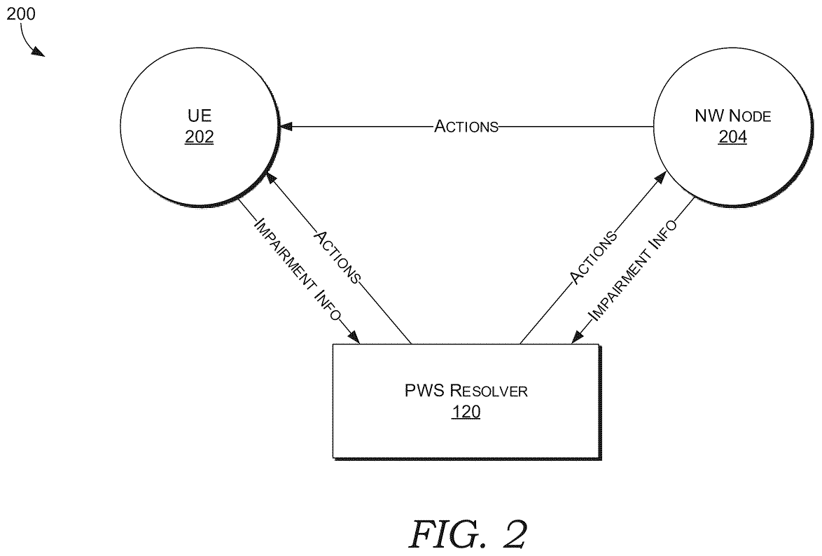

Turning now to FIG. 2, a flow chart 200 is provided for determining and triggering mitigation steps. As discussed above, PWS communications contain important and often time sensitive communications attached to SIB transmissions which require receipt and decoding by UEs in order for users to obtain the important and sometimes urgent communications. These PWS communications are transmitted by a Cell Broadcast Entity (CBE) which are then transmitted through various stages of telecommunication networks to eventually arrive at and be decoded by UEs. There are any number of issues that could cause delay of these messages or that could cause these messages not to be received. For example, if a network is too congested, the UEs or network may be overtaxed to an extent that the PWS communication cannot be delivered to the UE, or if delivered to the UE cannot be decoded by the UE. In order to avoid this, aspects are provided which ensure that these important PWS communications are delivered and decoded properly. In embodiments, the UE 202, network (NW) Node 204, PWS Resolver 120 or any combination of the three may determine when mitigation steps are needed, and what mitigation steps to initiate. As shown in FIG. 2, the NW Node 204 may cause actions to be taken by the UE 202. Both the NW Node 204 and the UE 202 may transmit impairment information to the PWS Resolver 120, and the PWS Resolver 120 may cause actions to be initiated by the UE 202. Additionally, the UE 202 may determine the need for mitigation steps without receiving actions to initiate from either the NW Node 204 or the PWS Resolver 120 and without delivering impairment information to PWS Resolver 120. In said embodiments, the UE 202 may determine the need for impairment steps and take certain actions to alleviate the impairment.

In embodiments, each of the UE 202, NW Node 204, and PWS Resolver 120 may determine that mitigation steps are required. In each of these embodiments, the need for mitigation steps may be determined at various stages of the PWS communication. For example, the UE 202 may determine that an SIB communication has been received containing a PWS communication that needs decoding. The UE may determine that given the current connection or network environment that the UE cannot decode the SIB. Or, the UE may attempt to decode the PWS communication a set number of times, and if the UE cannot decode the PWS communication after the predetermined number of attempts, the UE may determine that a mitigation step is required. From the perspective of the network, the NW Node 204, or a system associated with the telecommunications network may determine that particular nodes or delivery methods are inactive, faulty, or congested. Based on this determination, the NW Node 204 may determine which UEs are at risk of not receiving the PWS communications and proactively take mitigation steps to ensure delivery. The NW Node 204 may take mitigation steps at a UE-by-UE basis, at a node-by-node basis, or may take mitigation steps at the telecommunications network level.

In additional or alternative embodiments, the PWS Resolver 120 may determine that impairment steps are needed and cause the NW Node 204 or UE 202 to take mitigation steps. In embodiments, the PWS Resolver 120 may receive impairment information from the UE 202 or the NW Node 204. This impairment information may be transmitted or collected at regular intervals, or may be transmitted or collected under certain conditions. Impairment information may be any set of data indicating that a node or UE are experiencing issues. For example, impairment information received from NW Node 204 may be a report of physical damage to the NW Node 204 such as damage from a storm. Impairment information may comprise evidence of network congestion based on an excess number of UEs connected to the NW Node 204 or a number of UEs exceeding the bandwidth associated with the NW Node 204. Further impairments could comprise malfunctioning hardware or software, overheating components, or lack of power. Impairment information collected by the PWS Resolver may be used to detect impairments to the NW Node 204 for any number of reasons.

As discussed above, the PWS Resolver 120 may be software or hardware communicatively connected to the telecommunication network. The PWS Resolver may also be connected to the UE 202 through a downloadable or cloud-based application installed on or connected to the UE 202. In said embodiments, the PWS Resolver 120 may use the application to collect impairment information from the UE 202 and may transmit mitigation instructions to the UE 202 through the application. The PWS Resolver 120 may collect data related to potential impairments from the UE 202 such as latency the UE 202 is experiencing. The PWS Resolver 120 may also utilize GPS data received from the UE 202 to indicate that the UE 202 is in a geographical area experiencing a network outage or issue with the associated NW Node 204. The PWS Resolver 120 may use GPS data received from the UE 202 to determine that the UE 202 is in a geographic area being serviced by an impaired NW Node 204. As with the impairment information received from the NW Node 204 discussed above, the PWS Resolver 120 may utilize any set of impairment data to determine that the UE 202 is impaired or connected to an impaired NW Node 204 which may create errors in the receipt or decoding of a PWS communication. Any number of impairment types may be detected by the UE 202, NW Node 204, and PWS Resolver 120 and once it has been determined that mitigation steps are required, each of the UE 202, NW Node 204, and PWS Resolver 120 may take mitigation steps to assist in the delivery of the PWS communication.

Once an impairment has been detected, the NW Node 204, may take any number of mitigation steps in order to ensure that the PWS communication is properly delivered and decoded. For example, the NW Node 204 may release and redirect the UE 202, initiate a handover, conduct cell barring, or terminate a cell as a primary cell. In release and redirect, the NW Node 204 releases the UE from a current cell and redirects the UE to a separate frequency or RAT. A release and redirect includes releasing a UE from a node or cell that it is currently communicatively connected to and providing that UE with a frequency with which the UE may search for a new node or cell. A handover includes transmitting a handover request from the impaired cell or node to a new cell or node. This allows for the impaired cell to hand the UE over to the new node without the UE needing to search for new cells. Cell barring may comprise the network determining that a cell or node is malfunctioning and disallowing connections to that cell. This indicates to UEs that the cell or node is not available for connection and causes the UE to search for and connect to a new cell. And finally, the network may also transmit instructions to a cell or node to cease communication as a primary cell and initiate communications as a secondary cell.

In each of these embodiments, the mitigation step may be initiated once an impairment is detected and the mitigation step may be halted once the PWS communication has been delivered and decoded. For example, if the NW Node 204 initiates a handover to a new cell, it may be determined that the UE 202 successfully connects to the new cell and that the PWS communication is received by and decoded by the UE 202. Once this has been determined, the new cell may initiate a handover from the new cell to the impaired cell to which the UE 202 was originally connected. As such, the mitigation step is halted and the UE 202 is returned to its original cell.

In additional or alternative embodiments, the UE 202 may take mitigation steps without receiving instructions from the NW Node 204 or PWS Resolver 120. The UE 202 may take a number of mitigations steps such that the message can be decoded. For example, the UE 202 may change the network cell, network frequency, or change the Radio Access Technology in order to find a connection that will allow for the decoding of the PWS communication. In additional or alternative embodiments, the UE 202 may search for a different telecommunication provider than its standard telecommunication provider and enter a roaming state until it is confirmed that the PWS communication was transmitted and decoded. By way of example, the UE 202 may detect that an SIB transmission comprising a PWS communication is being transmitted to the UE 202. The UE 202 may attempt to decode the PWS communication and determine that the UE 202 is unable to decode the PWS communication. In embodiments, the UE 202 may attempt to decode the PWS communication a predetermined number of times, before taking mitigation steps. If it is detected that the PWS communication was decoded after any of the predetermined steps, a mitigation step is not required. If the UE 202 is unable to decode the PWS communication, the UE 202 may take any number of mitigation steps in order to allow for the receipt and decoding of the PWS communication. For example, the UE 202 may enter a roaming state and search for other network providers to which the UE 202 may connect in order to decode the PWS communication. In additional or alternative embodiments, once the UE 202 has determined that the PWS communication cannot be decoded, the UE 202 may search for a new network cell or frequency so that it may re attempt to decode the PWS communication.

The PWS Resolver 120 may additionally or alternatively transmit instructions to the NW Node 204 or the UE 202. For example, if the PWS Resolver 120 receives impairment information from the NW Node 204 indicating that said node is impaired, the PWS Resolver 120 may transmit instructions to the NW Node 204 to conduct a handover. In said embodiment, the NW Node 204 would transmit the request to transfer a connected UE 202 to a new cell which is not impaired and release the UE 202 such that it may connect to the new unimpaired node. Additionally or alternatively, the PWS Resolver 120 may transmit instructions to the impaired cell, NW Node 204, to cease actions as a primary cell and initiate actions only as a secondary cell. In embodiments, the PWS Resolver 120 may transmit instructions to the NW Node 204 experiencing impairments, wherein the instructions flag the NW Node 204 as an impaired cell. In embodiments, the PWS Resolver 120 may additionally or alternatively transmit instructions to the UE 202 indicating which cells are barred such that the UE 202 may cease communication with a barred cell and connect to a cell which is not barred. The PWS Resolver 120 may initiate any number of mitigation steps to handle the impairments of any number of telecommunication network nodes such as NW Node 204.

The PWS Resolver 120 may additionally or alternatively transmit instructions to a UE 202 based on detecting an impairment blocking receipt of a PWS communication. The PWS Resolver 120 may transmit instructions to either the NW Node 204 or UE 202, and may cause any number of mitigation steps to be taken by either the NW Node 204, UE 202, or both. For example, the PWS Resolver 120 may determine, based on impairment information received, that the UE 202 is impaired and unable to receive or decode a PWS communication. The PWS Resolver 120 may transmit instructions to the UE 202 wherein the instructions cause the UE 202 to take a mitigation step such as entering a roaming state to connect to a provider which is not the standard telecommunication provider for the UE 202. The PWS Resolver 120 may then receive information indicating that the UE 202 has received and decoded the PWS communication and, based on this, determine that the mitigation step is no longer needed. Based on this determination, the PWS Resolver 120 may transmit instructions for the UE 202 to exit the roaming state and return to the standard telecommunication provider for the UE 202.

In embodiments, a PWS communication may be associated with an importance level. The type of mitigation step taken by either the UE 202, NW Node 204, or PWS Resolver 120 may be affected by the importance level of the PWS communication. In embodiments, the NW Node 204 or PWS Resolver 120 may determine the importance level or severity of a PWS communication when the PWS communication is transmitted to a UE 202. The NW Node 204 or PWS Resolver 120 may determine when a PWS communication is associated with an importance level or severity type. Additionally or alternatively, the NW Node 204 or PWS Resolver 120 may determine mitigation steps to be taken based on the determined importance level or severity type. For example, if either the NW Node 204 or the PWS Resolver 120 determine that the PWS communication is of a high importance level or severity type, the NW Node 204 or the PWS may take the mitigation action of, for example, cell barring or release with redirect, or instructions for a UE to enter a roaming state. If it is determined that the PWS communication is of a low importance level or severity type, then the mitigation step could be, for example, a handover.

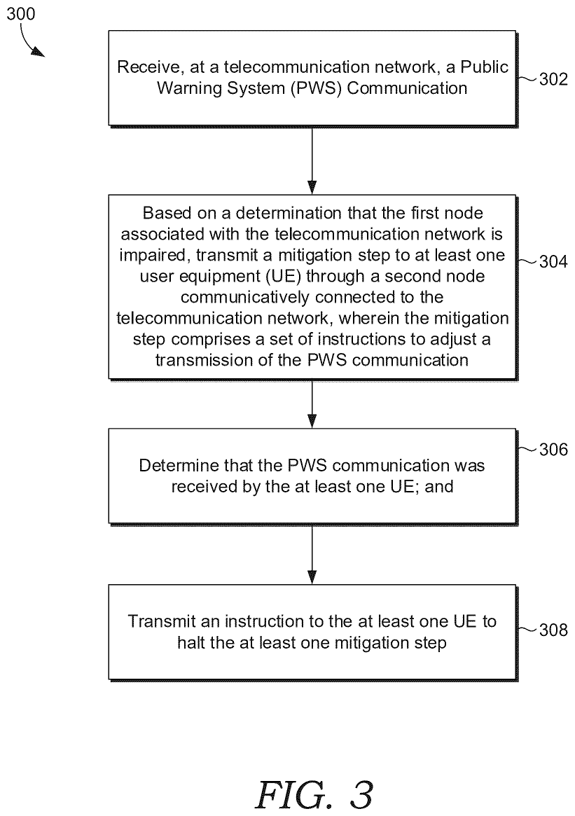

Turning now to FIG. 3 a flow chart is provided for a method 300 for mitigating errors in a transmission of a PWS communication. Initially, at block 302, an indication that a PWS communication is being transmitted to at least one UE is received. In embodiments, this PWS communication may be associated with an importance level or a severity level. At block 304, based on a determination that a first node associated with the telecommunication network is impaired, a mitigation step is transmitted to at least one UE through a second node communicatively connected to the telecommunication network, wherein the mitigation step comprises a set of instructions to adjust a transmission of the PWS communication. The node may be determined to be impaired based on hardware or software malfunctions. In embodiments, this impairment may be detected by either the PWS Resolver or the telecommunications network. For example, the PWS Resolver may receive an indication that the node is impaired based on traffic data received from the telecommunications network or the node indicating that the node does not have the bandwidth to handle further communication. The impairment may be determined based on a notification received from the node to either the PWS Resolver, UE, or telecommunications network indicating that there has been a software error or a hardware malfunction. In additional or alternative embodiments, it may be determined by either the PWS Resolver, UE, or telecommunication network that the node is impaired based on a lack of information received from the node indicating that the node is not active or is impaired. In embodiments, the mitigation step is transmitted through a second node and to the UE for the UE to facilitate or act on the mitigation step instructions. In additional or alternative embodiments, the mitigation step is transmitted to a second node associated with the telecommunications network, wherein the second node facilitates or acts on the mitigation step.

For example, in an embodiment where the mitigation step is transmitted through a second node, the mitigation step may be an instruction to the UE to enter a roaming state so that it may receive the PWS communication. In an embodiment where the mitigation step is transmitted to a second node, the mitigation step may be a handover or release with redirect. In embodiments, the mitigation step may comprise cell barring such that the original impaired node is barred from connection to UEs for the period of time required for the PWS communication to be transmitted and decoded by a UE. The mitigation step may comprise any instruction or set of instruction to adjust the transmission of the PWS communication. For example, the mitigation step may comprise causing the at least one UE to disconnect from the first node, and causing the at least one UE to connect to the second node. Or, the mitigation step may comprise instructions to a second node instructing the second node to connect to the UE. By way of an additional or alternative example, the mitigation step may comprise instructions causing the at least one UE to enter a roaming state or to change from a first frequency to a second frequency.

Instead of or in addition to determining that a node of a telecommunication network is impaired, it may be determined that a UE did not receive the PWS communication. This may be determined by the UE, the PWS Resolver, a node of the network, or the telecommunication network. Based on determining the UE did not received the PWS communication a mitigation step is transmitted to the UE, wherein the mitigation step comprises a set of instructions to adjust the transmission of the PWS communication. In embodiments, this determination is made by the UE, or may additionally or alternatively be made by the PWS Resolver. The mitigation step transmitted to the UE may be to enter a roaming state, disconnect from the current node and connect to a new second node,

At block 306, it is determined that the PWS communication was received by the at least one UE. In embodiments, this determination is made by the UE and the UE may transmit a communication to the PWS Resolver or telecommunication network indicating that the PWS communication was received. This determination may be made by the PWS Resolver based on information received from the UE either through a software application stored on the UE, or through a communication received by the UE. This determination may additionally or alternatively be made by the telecommunications network or the node servicing the UE. In any of these embodiments, the UE is determined to have received the PWS communication. The PWS communication may additionally or alternatively be caused to display on a graphical user interface of the UE.

At block 308, instructions are transmitted to the at least one UE to halt the at least one mitigation step. For example, the instructions to halt the mitigation step may be instructions to halt the roaming state of the UE, change from a second frequency back to a first frequency, or instructions transmitted to the UE to return to the first node that was previously servicing the UE when impaired. In additional or alternative embodiments, an instruction to halt the mitigation step is transmitted to the node servicing the UE at the time the PWS communication is determine to have been received. In such embodiments, the instructions to halt the mitigation step may be a release with redirect or handover of the UE back to the original node, or may be instructions to cease cell barring of the original node. The instructions to halt the mitigation step may additionally or alternatively be instructions to the UE to disconnect from the second node and reconnect to the first node, or instructions to the second node causing the second node to disconnect from the UE.

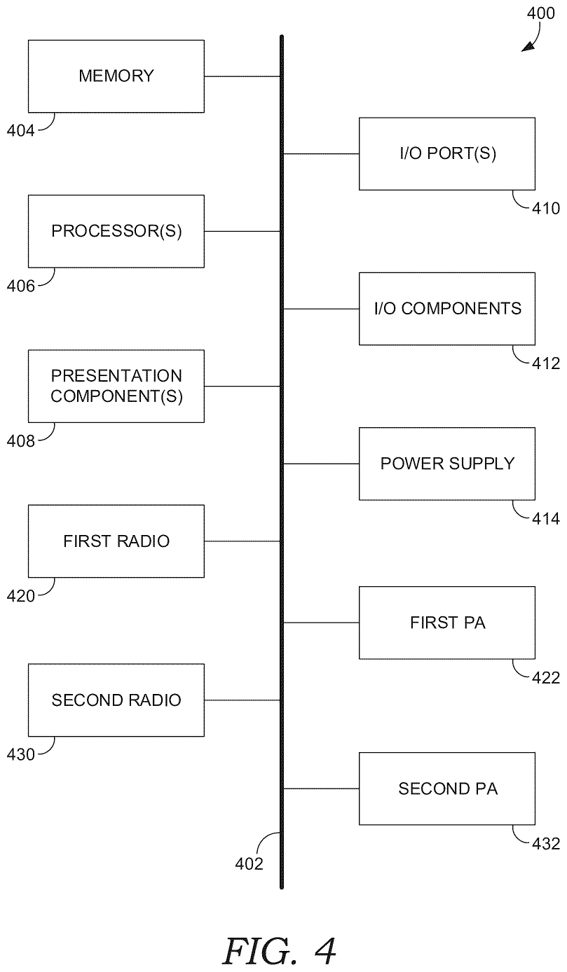

Having described an overview of some embodiments of the present technology, an example computing environment in which embodiments of the present technology may be implemented is described below in order to provide a general context for various aspects of the present technology. Referring to FIG. 4, an exemplary device is shown and designated generally as computing device 400 that is suitable for use in implementations of the present disclosure. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. In aspects, the computing device 400 is generally defined by its capability to transmit one or more signals to a an access point and receive one or more signals from the access point (or some other access point); the computing device 400 may be referred to herein as a user equipment, wireless communication device, or user device, The computing device 400 may take many forms; non-limiting examples of the computing device 400 include a cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, computing device 400 includes bus 402 that directly or indirectly couples the following devices: memory 404, one or more processors 406, one or more presentation components 408, input/output (I/O) ports 410, I/O components 412, and power supply 414. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component 408 such as a display device to be one of I/O components 412. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. Memory 404 may be removable, nonremovable, or a combination thereof. Exemplary memory includes solid-state memory, hard drives, optical-disc drives, etc. Computing device 400 includes one or more processors 406 that read data from various entities such as bus 402, memory 404 or I/O components 412. One or more presentation components 408 presents data indications to a person or other device. Exemplary one or more presentation components 408 include a display device, speaker, printing component, vibrating component, etc. I/O ports 410 allow computing device 400 to be logically coupled to other devices including I/O components 412, some of which may be built in computing device 400. Illustrative I/O components 412 include a microphone, joystick, game pad, satellite dish, scanner, printer, wireless device, etc.

A first radio 420 and second radio 430 represent radios that facilitate communication with one or more wireless networks using one or more wireless links. In aspects, the first radio 420 utilizes a first transmitter 422 to communicate with a wireless network on a first wireless link and the second radio 430 utilizes the second transmitter 432 to communicate with a wireless network on a second wireless link. Though two radios are shown, it is expressly conceived that a computing device with a single radio (i.e., the first radio 420 or the second radio 430) could facilitate communication over one or more wireless links with one or more wireless networks via both the first transmitter 422 and the second transmitter 432. Illustrative wireless telecommunications technologies include CDMA, GPRS, TDMA, GSM, and the like. One or both of the first radio 420 and the second radio 430 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 420 and the second radio 430 may be configured to communicate using the same protocol but in other aspects they may be configure dot communicate using different protocols. In some embodiments, including those that both radios or both wireless links are configured for communicating using the same protocol, the first radio 420 and the second radio 430 may be configured to communicate on distinct frequencies or frequency bands (e.g., as part of a carrier aggregation scheme). As can be appreciated, in various embodiments, each of the first radio 420 and the second radio 430 can be configured to support multiple technologies and/or multiple frequencies.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A non-transitory computer storage media storing computer-useable instructions that, when used by one or more processors, cause the processor to:
receive, at a telecommunication network, a Public Warning System (PWS) communication;
based on a determination that a first node associated with the telecommunication network is impaired, transmit a mitigation step to at least one user equipment (UE) through a second node communicatively connected to the telecommunication network, wherein the mitigation step comprises a set of instructions to adjust a transmission of the PWS communication;
determine that the PWS communication was received by the at least one UE; and
transmit an instruction to the at least one UE to halt the at least one mitigation step.

2. The non-transitory computer storage media of claim 1, wherein the determination that the first node associated with the telecommunication network is impaired comprises determining that the first node is experiencing a software malfunction.

3. The non-transitory computer storage media of claim 1 wherein the at least one mitigation step causes the at least one UE to disconnect from the first node, and causes the at least one UE to connect to the second node.

4. The non-transitory computer storage media of claim 3, wherein the halting the at least one mitigation step comprises causing the at least one UE to disconnect from the second node, and cause the at least one UE to connect to the first node.

5. The method of claim 1, wherein the PWS communication is associated with a high priority.

6. The method of claim 5, wherein the at least one mitigation step comprises causing the at least one UE to enter a roaming state.

7. The method of claim 6, wherein halting the at least one mitigation step comprises causing the at least one UE to exit a roaming state.

8. A system comprising:
one or more computer processing components configured to perform operations comprising:
receive, at a telecommunication network, a Public Warning System (PWS) communication;
based on a determination that a first node associated with the telecommunication network is impaired, transmit at least one mitigation step to a second node associated with the telecommunication network, wherein the mitigation step comprises a set of instruction to adjust a transmission of the PWS communication
determine that the PWS communication was received by at least one user equipment (UE); and
transmit an instruction to the second node associated with the telecommunication network, wherein the instruction comprise halting the at least one mitigation step.

9. The system of claim 8, wherein the determination that the first node associated with the telecommunication network is impaired comprises determining that the first node is experiencing a hardware malfunction.

10. The system of claim 8, wherein the determination that the first node associated with the telecommunication network is impaired comprises determining that the first node is experiencing a software malfunction.

11. The system of claim 8, wherein the at least one mitigation step causes the second node to connect to the UE.

12. The system of claim 11, wherein halting the at least one mitigation step comprises causing the second node to disconnect from the UE.

13. The system of claim 12, further comprising transmitting instructions to the first node to connect to the UE.

14. The system of claim 8, further comprising causing display of the PWS communication on a graphical user interface associated with the UE.

15. A method for mitigating errors in a transmission of Public Warning System (PWS) communication comprising:
receiving an indication that a PWS communication is being transmitted to at least one user equipment (UE);
determining that the UE did not receive the PWS communication;
transmitting a mitigation step to the UE, wherein the mitigation step comprises a set of instructions to adjust the transmission of the PWS communication; and
determining that the UE received the PWS communication.

16. The method of claim 15, wherein the PWS communication is associated with a low priority.

17. The method of claim 16, wherein the mitigation step comprises causing the UE to change from a first frequency to a second frequency.

18. The method of claim 17 further comprising transmitting instructions to the UE to halt the mitigation step.

19. The method of claim 18, wherein halting the mitigation step comprises causing the UE to change from the second frequency to the first.

20. The method of claim 15, further comprising causing display of the PWS communication on a graphical user interface associated with the UE.
